(19) United States
(12) Patent Application Publication
(10) Pub. No.: US 2025/0360852 A1
(43) Pub. Date: Nov. 27, 2025

(54) SEAT TRIM AND VEHICLE SEAT

(71) Applicants: NHK SPRING CO., LTD., Yokohama-shi (JP); SUBARU CORPORATION, Tokyo (JP)

(72) Inventors: Moriyasu SOMEYA, Yokohama-shi (JP); Syuhei KANEKO, Yokohama-shi (JP); Hideki HASUMI, Yokohama-shi (JP); Yusuke KOIZUMI, Yokohama-shi (JP); Yosuke ISHIYAMA, Tokyo (JP); Masato FUKUSHIMA, Tokyo (JP)

(21) Appl. No.: 19/205,861

(22) Filed: May 12, 2025

(30) Foreign Application Priority Data
May 21, 2024 (JP) 2024-082862

(51) Int. Cl. B60N 2/60

(52) U.S. Cl. CPC B60N 2/60

(57) ABSTRACT

A seat trim includes a trim main body and a pocket forming member. A seat width direction intermediate portion of a bag-shaped section of the pocket forming member is joined to the trim main body, such that the bag-shaped section is divided in the seat width direction, and an opening of a pocket formed between the pocket forming member and the trim main body is divided in the seat width direction. First reinforcement portions are provided at an interior of the bag-shaped section respectively at a seat width direction one side and a seat width direction other side of a divider section of the bag-shaped section. A second reinforcement portion provided at the interior of the bag-shaped section by being provided continuously without a break from the seat width direction one side to the seat width direction other side of the divider section of the bag-shaped section.

### CROSS-REFERENCE TO RELATED APPLICATION

This application is based on and claims priority under 35 USC 119 from Japanese Patent Application No. 2024-082862, filed on May 21, 2024, the disclosure of which is incorporated by reference herein.

### BACKGROUND

### Technical Field

The present disclosure relates to a seat trim and a vehicle seat.

### Related Art

A seat trim (seat cover) including a pocket is disclosed in Japanese Patent Application Laid-Open (JP-A) Nos. 2019-111869, 2016-155541, and 2016-117297. In the seat trim described in JP-A No. 2019-111869, an edge portion of an opening of a pocket is reinforced by providing a resin plate at the interior of the edge portion of the opening of the pocket. Moreover, in the seat trims described in JP-A Nos. 2016-155541 and 2016-117297, an edge portion of an opening of a pocket is reinforced by providing a wire at the interior of the edge portion of the opening of the pocket. Creases are thereby suppressed from being generated at the edge portion of the opening of the pocket.

However, although the configurations described in JP-A Nos. 2019-111869, 2016-155541, and 2016-117297 are useful configurations from the perspective of being able to suppress the generation of creases at an edge portion of an opening of a pocket, no consideration is made into suppressing the generation of creases at an edge portion of an opening of a pocket configured with the opening of the pocket divided into plural sections.

### SUMMARY

The present disclosure discloses a seat trim and a vehicle seat capable of suppressing the generation of creases in an edge portion of an opening of a pocket configured with the opening of the pocket divided into plural sections.

A seat trim of a first aspect includes a trim main body, a pocket forming member, first reinforcement portions, and a second reinforcement portion. The trim main body configures a surface portion of a seatback that supports a back of a seated occupant. The pocket forming member forms a pocket at a back face side of the trim main body between the pocket forming member and the trim main body, configuring a bag-shaped section with an edge portion at an opening side of the pocket and formed in a bag shape along a seat width direction, and with a seat width direction intermediate portion of the bag-shaped section joined to the trim main body such that the bag-shaped section is divided in the seat width direction with an opening of the pocket divided in the seat width direction. The first reinforcement portions reinforce the bag-shaped section and are provided at an interior of the bag-shaped section respectively at a seat width direction one side and a seat width direction other side of a divider section of the bag-shaped section. The second reinforcement portion reinforces the bag-shaped section and is provided at the interior of the bag-shaped section by being provided continuously without a break from the seat width direction one side to the seat width direction other side of the divider section of the bag-shaped section.

In the seat trim of the first aspect, the pocket is formed between the trim main body and the pocket forming member. Moreover, an edge portion at the opening side of the pocket on the pocket forming member is configured by the bag-shaped section formed in a bag shape along the seat width direction. The seat width direction intermediate portion of the bag-shaped section is joined to the trim main body. The bag-shaped section is thereby divided in the seat width direction and the opening of the pocket is thereby divided in the seat width direction. The first reinforcement portions are provided at the interior of the bag-shaped section of the pocket forming member respectively at the seat width direction one side and the seat width direction other side of the divider section of the bag-shaped section. The seat width direction one side of the divider section of the bag-shaped section is thereby reinforced by one of the first reinforcement portions, and the seat width direction other side of the divider section of the bag-shaped section is thereby reinforced by the other of the first reinforcement portions. The second reinforcement portion is provided at the interior of the bag-shaped section. The second reinforcement portion is provided continuously without break from the seat width direction one side across to the seat width direction other side of the divider section of the bag-shaped section. The bag-shaped section is thereby reinforced by the second reinforcement portion. By providing the second reinforcement portion in addition to the respective first reinforcement portions in this manner, an edge portion of an opening of the pocket can be reinforced even in a configuration in which the opening of the pocket is configured divided into plural sections. This thereby enables creases to be suppressed from being generated at the edge portion of the opening of the pocket even in a configuration in which the opening of the pocket is configured divided into plural sections.

A seat trim of a second aspect is the seat trim of the first aspect, wherein the seat width direction intermediate portion of the bag-shaped section is joined to the trim main body by sewing.

The seat trim of the second aspect enables the seat width direction intermediate portion of the bag-shaped section to be joined to the trim main body easily by sewing.

A seat trim of the third aspect is the seat trim of the first aspect or the second aspect, wherein the second reinforcement portion is provided at the interior of the bag-shaped section along an end at an open side of the opening of the pocket.

In the seat trim of the third aspect, creases can be suppressed from being generated at an end on the open end side of the opening of the pocket more easily than configurations in which the second reinforcement portion is not provided at the above-described position at the interior of the bag-shaped section.

A seat trim of a fourth aspect is the seat trim of any one aspect of the first aspect to the third aspect, wherein each of the first reinforcement portions and the second reinforcement portion is configured by a separate body.

In the seat trim of the fourth aspect, each of the first reinforcement portions and the second reinforcement portion is able to be assembled respectively at the interior of the bag-shaped section more easily than in a configuration in which the first reinforcement portions and the second reinforcement portion are configured integrated together as a single body.

A seat trim of a fifth aspect is the seat trim of the second aspect, wherein the second reinforcement portion is formed in a rod shape, and the second reinforcement portion is threaded through a gap between an inner face of the bag-shaped section and a seam section.

In the seat trim of the fifth aspect, the second reinforcement portion formed in a rod shape is inserted into the bag-shaped section and passed through the gap between the inner face of the bag-shaped section and the seam section. This accordingly enables the second reinforcement portion to be assembled at the interior of the bag-shaped section.

A vehicle seat of a sixth aspect includes a seatback including a seatback main body that supports a back of a seated occupant, and the seat trim of any one aspect of the first aspect to the fifth aspect attached to the seatback main body.

In the vehicle seat of the sixth aspect, the seat trim of any one aspect of the first aspect to the fifth aspect is attached to the seatback main body. In this seat trim, a pocket is formed between the trim main body and the pocket forming member. Moreover, the edge portion at the opening side of the pocket on the pocket forming member is configured by a bag-shaped section formed in a bag shape along the seat width direction. The seat width direction intermediate portion of the bag-shaped section is joined to the trim main body. The bag-shaped section is thereby divided in the seat width direction, and the opening of the pocket is thereby divided in the seat width direction. First reinforcement portions are provided at the interior of the bag-shaped section of the pocket forming member respectively at a seat width direction one side and a seat width direction other side of a divider section of the bag-shaped section. This means that a seat width direction one side of the divider section of the bag-shaped section is reinforced by one of the first reinforcement portions and a seat width direction other side of the divider section of the bag-shaped section is reinforced by the other of the first reinforcement portions. The second reinforcement portion is provided at the interior of the bag-shaped section. The second reinforcement portion is provided continuously without break from the seat width direction one side across to the seat width direction other side of the divider section of the bag-shaped section. The bag-shaped section is accordingly reinforced by the second reinforcement portion. Providing the second reinforcement portion in addition to the respective first reinforcement portions in this manner enables the edge portion of an opening of a pocket to be reinforced even in a configuration in which the opening of the pocket is divided into plural sections. This enables creases to be suppressed from being generated at the edge portion of the opening of the pocket even in a configuration in which the opening of the pocket is configured divided into plural sections.

The seat trim and the vehicle seat according to the present disclosure exhibit the effect of being able to suppress creases from being generated at the edge portion of the opening of the pocket even in a configuration in which the opening of the pocket is configured divided into plural sections.

### BRIEF DESCRIPTION OF THE DRAWINGS

An exemplary embodiment of the present disclosure will be described in detail based on the following figures, wherein:

FIG. 1 is a side view schematically illustrating a vehicle seat illustrated in a state prior to a back trim being attached to a seatback main body;

FIG. 2 is a perspective view of a back trim viewed diagonally from the left and rear;

FIG. 3 is a cross-section illustrating a cross-section of a back trim sectioned along line 3-3 of FIG. 2; and

FIG. 4 is a back view illustrating an enlargement of part of the back trim.

### DETAILED DESCRIPTION

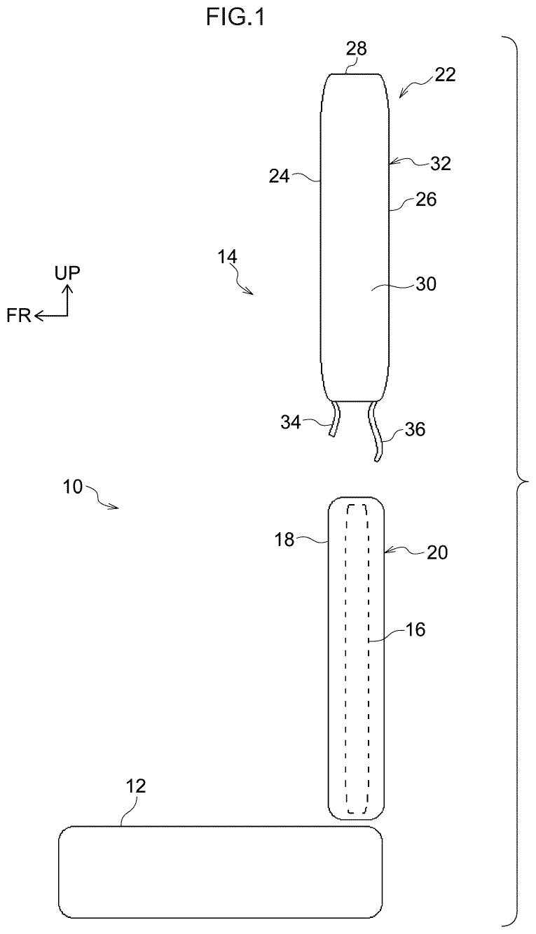

Description follows regarding a vehicle seat 10 according to an exemplary embodiment of the present disclosure, with reference to FIG. 1 to FIG. 4. Note that in the drawings, arrow FR indicates a seat front side direction, an arrow UP indicates a seat upward direction, an arrow LH indicates a left side in a seat width direction, and an arrow RH indicates a right side in the seat width direction. Moreover, unless explicitly stated otherwise, reference to front-rear, up-down, and left-right directions means front-rear in the seat front-rear direction, up-down in the seat height direction (up-down direction), and left-right in the seat width direction.

As illustrated in FIG. 1, the vehicle seat 10 of the present exemplary embodiment includes a seat cushion 12 to support the buttocks of a seated occupant from below, and a seatback 14 to support the back of the seated occupant from the rear. The seatback 14 includes a back frame 16 configuring framework of the seatback 14, and a back pad 18 attached to the back frame 16. The back frame 16 and the back pad 18 together configure a seatback main body 20 that bears load from the seated occupant. The seatback 14 includes a back trim 22 as a seat trim attached to the seatback main body 20.

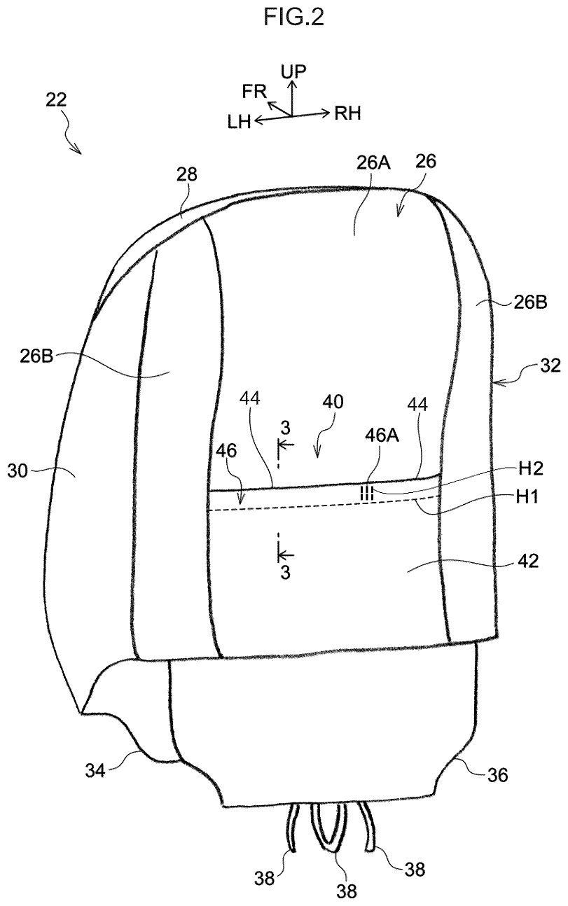

As illustrated in FIG. 1 and FIG. 2, the back trim 22 is formed, as an example, using a fabric, leather, synthetic leather, or the like. The back trim 22 includes a front face covering section 24 that covers a front face of the seatback main body 20, a back face covering section 26 that covers a back face of the seatback main body 20, an upper face covering section 28 that covers an upper face of the seatback main body 20, and a left-right pair of side face covering sections 30 that respectively cover left and right side faces of the seatback main body 20. The front face covering section 24, the back face covering section 26, the upper face covering section 28, and the left-right pair of side face covering sections 30 together configure a trim main body 32 formed in a bag shape. A configuration is adopted in which the trim main body 32 forms a surface portion of the seatback 14 in a state in which the back trim 22 has been attached to the seatback main body 20. The back trim 22 includes a front extension portion 34 extending downward from the front face covering section 24, a rear extension portion 36 extending downward from the back face covering section 26, and anchor members 38 attached to the rear extension portion 36 at an end portion on the opposite side to the back face covering section 26. Note that the anchor members 38 are omitted from illustration in FIG. 1. The front extension portion 34 is configured so as to be disposed along a bottom face of the seatback main body 20. The rear extension portion 36 is configured so as to be disposed along the bottom face from the rear face of the seat cushion 12. Furthermore, the anchor members 38 are configured so as to be anchored to anchor site(s) provided to a lower portion of the seat cushion 12.

The back face covering section 26 includes a central covering portion 26A that covers most of a left-right direction intermediate portion of the back face of the seatback main body 20, and a left-right pair of side covering portions 26B that respectively cover left-right direction side portions of the back face of the seatback main body 20. Moreover, the central covering portion 26A and the left-right pair of side covering portions 26B are joined together by sewing or the like.

Moreover, the back trim 22 includes a pocket forming member 42 that forms a pocket 40 on the back face side of the back trim 22. The pocket forming member 42 is formed in a rectangular shape when viewed from the rear. A lower end portion of the pocket forming member 42 is joined to a lower end portion of the central covering portion 26A by sewing or the like. The two left and right direction end portions of the pocket forming member 42 are respectively joined to the two left and right direction end portions of the central covering portion 26A by sewing or the like. The pocket 40 including an opening 44 at an upper side thereof is thereby formed between the central covering portion 26A and the pocket forming member 42.

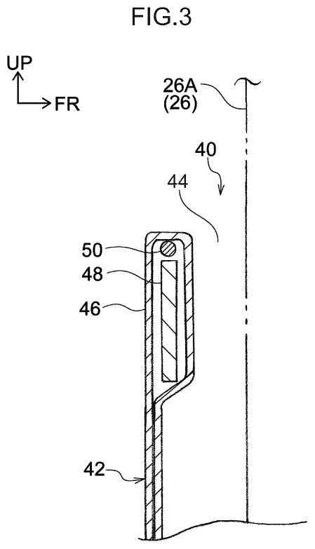

As illustrated in FIG. 2 and FIG. 3, a location at the upper side of the pocket forming member 42 is sewn along the left-right direction in a state folded back toward the interior of the pocket 40. Note that this seam section is illustrated by the broken line H1 in FIG. 2. The edge portion on the opening 44 side of the pocket 40 of the pocket forming member 42 is configured by a bag-shaped section 46 formed in a bag shape along the seat width direction.

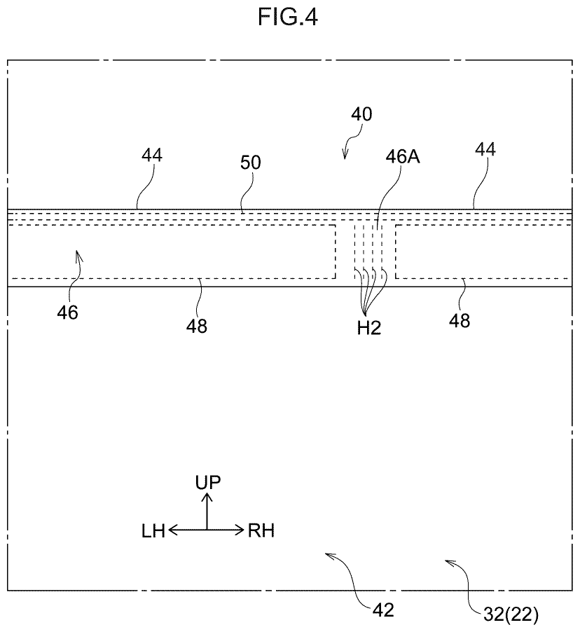

As illustrated in FIG. 2 and FIG. 4, height direction intermediate portions of one part 46A of the seat width direction intermediate portion of the bag-shaped section 46 is joined to the central covering portion 26A by sewing. Note that this seam section is illustrated in FIG. 4 by broken lines H2. The bag-shaped section 46 is thereby divided in the seat width direction with the seam section H2 as a boundary. The opening 44 of the pocket 40 is also divided in the seat width direction with the seam section H2 as a boundary.

As illustrated in FIG. 3 and FIG. 4, first reinforcement portions 48 to reinforce the bag-shaped section 46 and also to retain the shape of the bag-shaped section 46 are provided at the interior of the bag-shaped section 46 and respectively at the left and right sides of the seam section H2, which is a divider section of the bag-shaped section 46. The two first reinforcement portions 48 are, as an example, formed using a resin material, and are each formed in a plate shape that extends in both the height direction and the left-right direction with a thickness direction in the front-rear direction. The profile of each of the first reinforcement portions 48 as viewed from the rear is a rectangular profile having a length direction along the left-right direction.

Moreover, a second reinforcement portion 50 to reinforce the bag-shaped section 46 and also to retain the shape of the bag-shaped section 46 is provided at the interior of the bag-shaped section 46. The second reinforcement portion 50 is, as an example, formed using a metal material by wire or the like that has been formed in a rod shape (linear shape). The second reinforcement portion 50 is provided at the interior of the bag-shaped section 46 continuously without break from a seat width direction one side across to a seat width direction other side with respect to the seam section H2, which is the divider section of the bag-shaped section 46. Furthermore, the second reinforcement portion 50 is threaded through a gap between the inner face of the bag-shaped section 46 and the seam section H2. The second reinforcement portion 50 is provided at the interior of the bag-shaped section 46 along an upper edge of the two first reinforcement portions 48 along an end (upper side end) of an open end side of the opening 44 of the pocket 40.

### Operation and Advantageous Effects of Present Exemplary Embodiment

Description follows regarding the operation and advantageous effects of the present exemplary embodiment.

As illustrated in FIG. 2 to FIG. 4, in the back trim 22 of the vehicle seat 10 of the present exemplary embodiment as described above, the pocket 40 including the opening 44 on the upper side thereof is formed between the central covering portion 26A and the pocket forming member 42. This thereby enables an occupant of a vehicle to store small items and the like in the pocket 40.

Moreover, the edge portion on the opening side of the pocket 40 in the pocket forming member 42 is configured by the bag-shaped section 46 formed in a bag shape along the seat width direction. The first reinforcement portions 48 are provided at the interior of the bag-shaped section 46 of the pocket forming member 42 respectively at the left and right sides of the seam section H2 of the bag-shaped section 46. This means that a location of the bag-shaped section 46 on the left side of the seam section H2 is reinforced by one of the first reinforcement portions 48. Moreover, a location of the bag-shaped section 46 on the right side of the seam section H2 is reinforced by the other of the first reinforcement portions 48.

Moreover, the second reinforcement portion 50 is provided in the interior of the bag-shaped section 46. The second reinforcement portion 50 is provided continuously from a seat width direction one side across to a seat width direction other side with respect to the seam section H2 of the bag-shaped section 46. This means that the bag-shaped section 46 is reinforced by the second reinforcement portion 50. As a result thereof, creases can be suppressed from being generated in the one part 46A of the seat width direction intermediate portion (a place divided by the seam section H2) of the bag-shaped section 46. Due to the second reinforcement portion 50 being provided in addition to the first reinforcement portions 48, the edge portion of the opening 44 of the pocket 40 can be reinforced even in a configuration in which the opening 44 of the pocket 40 is divided into plural sections. This thereby enables creases to be suppressed from being generated at the edge portion of the opening 44 of the pocket 40 even in a configuration in which the opening 44 of the pocket 40 is divided into plural sections.

Moreover, in the present exemplary embodiment, the one part 46A of the seat width direction intermediate portion of the bag-shaped section 46 can be easily joined to the central covering portion 26A by sewing.

Moreover, in the present exemplary embodiment, the second reinforcement portion 50 is provided along the end (upper side end) at the open side of the opening 44 of the pocket 40 at the interior of the bag-shaped section 46. In such a configuration, compared to a configuration in which the second reinforcement portion 50 is provided further to the lower side than this position, creases can be better suppressed from being generated at the end on the open end side of the opening 44 of the pocket 40, and also the end on the open end side of the opening 44 of the pocket 40 can be better suppressed from sagging.

Moreover, in the present exemplary embodiment, each of the first reinforcement portions 48 and the second reinforcement portions 50 are formed as separated bodies. Such a configuration enables the first reinforcement portions 48 and the second reinforcement portion 50 to be more easily assembled to the interior of the bag-shaped section 46 than a configuration in which the first reinforcement portions 48 and the second reinforcement portion 50 have been integrated together.

Moreover, in the present exemplary embodiment, by inserting the second reinforcement portion 50 that has been formed in a rod shape into the bag-shaped section 46, and by passing it through a gap between the inner face of the bag-shaped section 46 and the seam section H2, the second reinforcement portion 50 can be assembled at the interior of the bag-shaped section 46.

Note that although the present exemplary embodiment has been described for an example in which the second reinforcement portion 50 is formed in a rod shape, the present disclosure is not limited thereto. For example, the second reinforcement portion 50 may be formed in the shape of an elongated plate.

Moreover, although the present exemplary embodiment has been described for an example in which each of the first reinforcement portions 48 and the second reinforcement portion 50 is a separate body, the present disclosure is not limited thereto. Whether or not the first reinforcement portions 48 and the second reinforcement portion 50 are separate bodies or a single body may be appropriately set in consideration of manufacturing processes and the like of the back trim 22.

Moreover, although the present exemplary embodiment has been described for an example in which the second reinforcement portion 50 is provided along the end (upper side end) at an open side of the opening 44 of the pocket 40 at the interior of the bag-shaped section 46, the present disclosure is not limited thereto. Whether or not to provide the second reinforcement portion 50 at the above-described position at the interior of the bag-shaped section 46 may be appropriately set in consideration of such factors as positions on the pocket 40 and the like where creases are liable to be generated.

Moreover, in the present exemplary embodiment an example has been described in which the one part 46A of the seat width direction intermediate portion of the bag-shaped section 46 is joined to the central covering portion 26A by sewing, the present disclosure is not limited thereto. For example, the one part 46A of the seat width direction intermediate portion of the bag-shaped section 46 may be joined to the central covering portion 26A by a crimping member or the like.

Although one exemplary embodiment of the present disclosure has been described above, the present disclosure is not limited thereto, and obviously various other embodiments may be implemented within a scope not departing from the spirit of the present disclosure.

What is claimed is:

1. A seat trim, comprising:
a trim main body that configures a surface portion of a seatback that supports a back of a seated occupant;
a pocket forming member that forms a pocket at a back face side of the trim main body between the pocket forming member and the trim main body, configuring a bag-shaped section with an edge portion at an opening side of the pocket and formed in a bag shape along a seat width direction, and with a seat width direction intermediate portion of the bag-shaped section joined to the trim main body such that the bag-shaped section is divided in the seat width direction with an opening of the pocket divided in the seat width direction;
first reinforcement portions that reinforce the bag-shaped section and are provided at an interior of the bag-shaped section respectively at a seat width direction one side and a seat width direction other side of a divider section of the bag-shaped section; and
a second reinforcement portion that reinforces the bag-shaped section and is provided at the interior of the bag-shaped section by being provided continuously without a break from the seat width direction one side to the seat width direction other side of the divider section of the bag-shaped section.

2. The seat trim of claim 1, wherein the seat width direction intermediate portion of the bag-shaped section is joined to the trim main body by sewing.

3. The seat trim of claim 1, wherein the second reinforcement portion is provided at the interior of the bag-shaped section along an end at an open side of the opening of the pocket.

4. The seat trim of claim 1, wherein each of the first reinforcement portions and the second reinforcement portion is configured by a separate body.

5. The seat trim of claim 2, wherein:
the second reinforcement portion is formed in a rod shape; and
the second reinforcement portion is threaded through a gap between an inner face of the bag-shaped section and a seam section.

6. A vehicle seat, comprising:
a seatback including a seatback main body that supports a back of a seated occupant; and
the seat trim of claim 1 attached to the seatback main body.
